(19) United States
(12) Patent Application Publication
(10) Pub. No.: US 2026/0037292 A1
(43) Pub. Date: Feb. 5, 2026

(54) PREEMPTIVE WORKLOAD RE-ASSIGNMENT WITHIN A MICROSERVICES ENVIRONMENT IN A DEVELOPMENT PIPELINE VIA TWO-DIMENSIONAL RUNTIME PREDICTIONS

(71) Applicant: DISH Network Technologies India Private Limited, Karnataka (IN)

(72) Inventors: Pavithra Babunarayanan, Tamil Nadu (IN); Jude Vedam, Karnataka (IN); Shishir Pandey, Telangana (IN)

(21) Appl. No.: 18/795,144

(22) Filed: Aug. 5, 2024

(51) Int. Cl. G06F 9/455

(52) U.S. Cl. CPC G06F 9/45558; G06F 2009/45595

(57) ABSTRACT

A microservices cloud environment features improved workload orchestration based on enhanced runtime performance predictions. The present disclosure provides solutions that can be implemented in a microservices development pipeline (e.g., a continuous integration and continuous delivery (CI/CD) pipeline), with the solutions enabling improved characterization of a true runtime performance of a microservice when deployed in a production, or user-facing, environment. Deployment of a microservice within the production environment is performed more optimally by characterizing the microservice via performance data collected specific to the production environment, and not to any other environment in the CI/CD pipeline. The environment-specific characterization of a microservice is based on predictions that link both workload type (e.g., compute-intensive, memory-intensive, network-intensive) and call volume. According to its characterization, a microservice can be re-assigned, after its initial deployment in a non-optimized node group, to an optimized node group in anticipation of the microservice's predicted peak call time.

### BACKGROUND

Public and private cloud environments provide on-demand availability of computer system resources and offer virtual machines that run workloads for users. Some cloud environments can operate with container orchestration systems (e.g., Kubernetes) that are used in hosting containerized applications and services on those cloud environments. Through a container orchestration system, execution of workloads in a cloud environment can be virtualized over multiple network resources and performed in isolation and/or in parallel. For example, a container orchestration system can manage a cluster of compute resources (e.g., servers, virtual machines) and run a containerized workload on a selected worker node. Improvements to workload/container orchestration can overcome operational resource costs and system inefficiencies stemming from orchestration inaccuracies.

### BRIEF DESCRIPTION OF THE DRAWINGS

FIGS. 1A-1B illustrate examples of cloud environments for hosting microservices workloads.

FIG. 2 illustrates an example workload distribution or orchestration system for implementing solutions for predictive and workload-centric orchestration, in accordance with embodiments of the present technology.

FIG. 3 is a flow diagram illustrating a process used in some implementations for predictively and preemptively re-assigning microservices workloads among node groupings in a cloud environment, in accordance with embodiments of the present technology.

FIG. 4 is a flow diagram illustrating a process used in some implementations for generating two-dimensional predictions for preemptive reassignment of microservices workloads among node groupings in a cloud environment, in accordance with embodiments of the present technology.

FIG. 5 illustrates an example of runtime performance data collected for a workload deployed in a particular cloud environment, in accordance with embodiments of the present technology.

FIG. 6 is a block diagram illustrating generation of two-dimensional predictions by which workloads can be preemptively re-assigned among node groupings in a cloud environment, in accordance with embodiments of the present technology.

FIG. 7 is a block diagram illustrating a machine learning (ML)-based system configured to generate two-dimensional predictions for preemptive pre-assignment of workloads to node groupings in a cloud environment, in accordance with embodiments of the present technology.

FIG. 8 illustrates one example of a suitable operating environment in which one or more of the present embodiments may be implemented.

The techniques introduced here may be better understood by referring to the following Detailed Description in conjunction with the accompanying drawings, in which like reference numerals indicate identical or functionally similar elements.

### DETAILED DESCRIPTION

### Overview and Example Technical Improvements

Aspects of the disclosed technology are directed to improving workload orchestration within microservices environments based on enhanced runtime performance predictions. The present disclosure provides solutions that can be implemented in a microservices development pipeline (e.g., a continuous integration and continuous delivery (CI/CD) pipeline), with the solutions enabling better ascertainment of a true runtime performance of a microservice when deployed in a production, or user-facing, environment. In particular, deployment of a microservice within the production environment is performed more optimally by characterizing the microservice via performance data collected specific to the production environment, and not to any other environment in the CI/CD pipeline. The environment-specific characterization of a microservice is based on predictions that link both workload type and call volume, and according to its characterization, a microservice can be re-assigned, after its initial deployment, to an optimized group of virtual computing nodes for the microservice's predicted peak call time.

According to aspects of the present disclosure, multiple applications that make up a user service (e.g., a TV streaming service, a video content and/or hosting service, a media subscription service) may each comprise or rely upon multiple containerized workloads in a microservices architecture. For example, one or multiple applications may call or make a query to a microservice for to obtain an encoded video, to look up and retrieve user data, to look up and retrieve content metadata, and/or the like. Various workloads or microservices may primarily entail reading and sending data, whereas other workloads or microservices may primarily entail data transformation, generation, or manipulation operations. Generally, containerized workloads during their runtime may be compute-intensive workloads, memory-intensive workloads, or input/output (I/O) intensive workloads. While the disclosed technology is described with respect to these three workload types, it will be understood that other and additional workload types may be accounted for and integrated into these solutions.

Example cloud environments include different kinds of virtual machines, or virtual machines optimized with different configurations of computing resources. An example cloud environment may include some virtual machines that are configured with relatively higher compute power, some virtual machines that are optimized for memory operations, and other virtual machines that are optimized for input/output operations. For example, an Amazon Web Services (AWS) environment offers C-Series (compute-optimized), R-Series (memory-optimized), and I-Series (network-optimized) virtual machines, and for example, running a memory-intensive workload on a C-Series virtual machine may result in non-optimal performance and may incur higher costs. Therefore, execution of a particular workload may be more cost-efficient at one virtual machine instead of another virtual machine, depending on the particular workload's runtime nature or performance characteristics.

However, the information about the runtime nature of a workload (e.g., whether it needs more CPU cores, more memory, more network throughput, or some combination thereof) is not known a priori. While the optimal workload distribution or orchestration needs the runtime nature of a workload before the workload is deployed on an environment's cluster, the workload's true runtime nature, at least with respect to the present cloud environment, can only be determined after deploying the workload. This leads to a cyclical dependency of information.

Some information regarding a workload's runtime nature can be gathered from running a performance test or load testing during the testing of the workload in a testing or non-production cluster environment. For example, in a microservices development pipeline, a microservice or workload is first deployed in a testing environment, prior to being deployed in a production, or user-facing, environment. However, a microservice's true runtime performance generally cannot be exactly replicated in the testing environment, for various reasons. For example, in the testing environment, the microservice or workload may be tested in isolation, without intermediate or dependent calls on other microservices that would be deployed therewith in the production environment. Additionally, the testing environment may be operated separately from the production environment and may not exactly replicate the resource configurations of the production environment. Further yet, developers of a workload may tune the workload's algorithm, remove bugs, and generally update the workload, which may result in a changing nature of the workload's runtime performance over time. But in the course of these updates to a workload, it would be expensive and time-consuming to take the workload through the development pipeline, for example, back to the testing environment for each change to the workload.

Aspects of the present disclosure overcome at least these technical challenges associated with workload orchestration. The disclosed methods and systems reduce reliance on performance data collected in the testing environment or other cloud clusters/environments, and rather, disclosed embodiments involve the collection of runtime performance data while a workload is deployed in the production environment. As such, an orchestrator system can obtain a more environment-specific and more current understanding of the workload's runtime performance, which it can then use to guide workload orchestration, deployment, and re-deployment/re-assignment. Over the course of its deployment at a cloud cluster/environment, a workload can be re-assigned to different clusters or nodes based on the continuous and/or repeated collection of its performance data. In doing so, the workload's deployment in the production environment remains flexible and agile over times in which the workload itself and other microservices it interacts with are updated or changed.

Furthermore, in example embodiments, a workload can be re-assigned or moved in a preemptive manner according to predictions generated for multiple upcoming time units or time windows. The performance data enables predictions on a call volume that a workload may receive, such as whether the workload will receive a peak call volume or a non-peak call volume at a given time. Then, in order for a workload to be optimally deployed at a time predicted to have peak call volume, the moving of the workload may be performed at a prior time predicted to have non-peak call volume. This preemptive workload re-distribution based on predicted call volume enables better preparation (e.g., by resource allocation or scaling) on the cloud cluster/environment's end.

### Example Cloud Environments and Systems

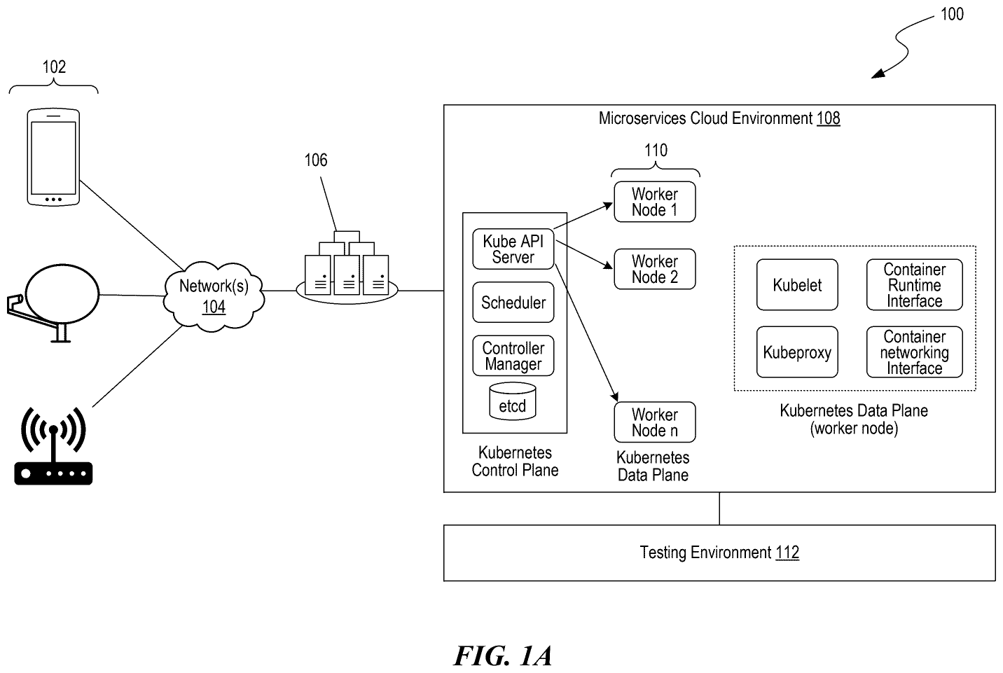

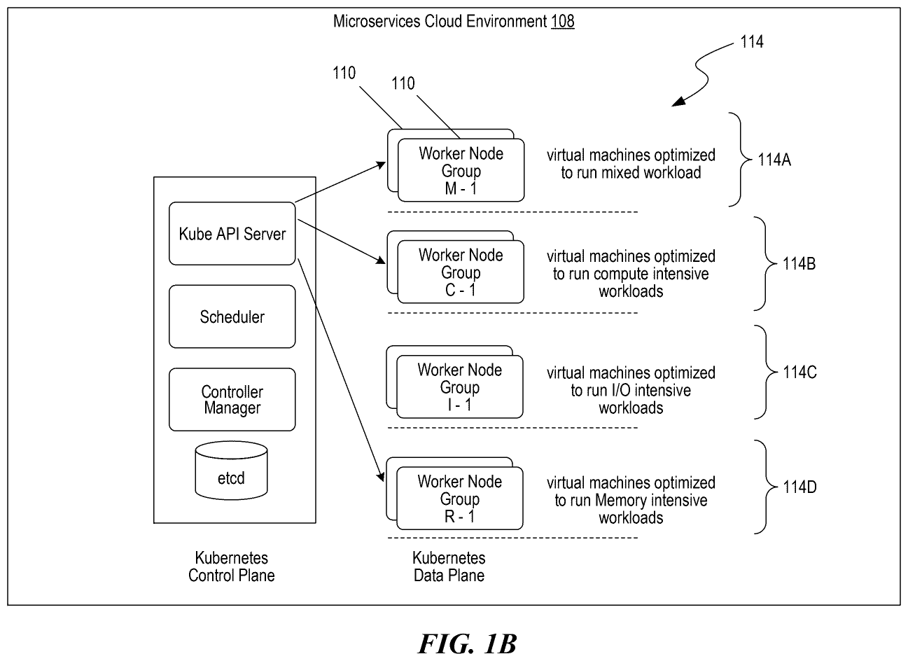

FIG. 1A illustrates an example of a microservices system 100 in which client-facing applications, such as a content streaming application or a content browser application, can rely upon microservices in order to better serve a large population of clients. Components of the systems comprising the microservices system 100 may be hardware components or software implemented on, and/or executed by, hardware components of the systems. For example, the microservices system 100 comprises client devices 102, network(s) 104, a server platform 106, and a microservices cloud environment 108.

Client devices 102 may be configured to receive services and content (e.g., video streaming content) via a network 104 from a server platform 106 (e.g., a content streaming/hosting platform). In various examples, a client device 102 may be a mobile phone, a smart OTA antenna, a broadcast module box (e.g., set-top box), or the like. In other example aspects, client device 102 may be a gateway device (e.g., router) that is in communication with sources, such as ISPs, cable networks, internet providers, or satellite networks. Other possible client devices include but are not limited to tablets, personal computers, televisions, etc. In aspects, a client device 102 may have access to a network from a gateway. In other aspects, client devices 102, may be equipped to receive data (e.g., release assessment information) from a gateway. The signals that client devices 102 may receive may be transmitted from a network node, such as a satellite broadcast tower, a cellular network base station, and/or the like. The network node may also be configured to communicate with network(s) 104, in addition to being able to communicate directly with client devices 102. In some examples, a client device may be a set-top box that is connected to a display device, such as a television (or a television that may have set-top box circuitry built into the television mainframe).

The server platform 106 hosts server applications that serve or deliver the content and/or services to client applications on the client devices 102. In order to provide flexibility and modularity, common functionalities used by the server applications may be implemented as microservices; the server applications can make queries or calls to a microservice, which may return retrieved and/or transformed data, send data, store data, and/or the like. Examples of microservices that can be used by multiple server applications can include video compression microservices, notification microservices, user authentication microservices, content management microservices (e.g., for retrieving and/or managing content metadata), content search microservices, payment microservices, and/or the like.

According to aspects of the present disclosure, these microservices may be developed for and deployed in a microservices cloud environment 108. By being deployed in a microservices cloud environment 108, the microservices can efficiently serve, with reduced latency, servers of the server platform 106 that may be distributed in different locations. The server platform 106 may access the microservices cloud environment 108 via a network, which may include public networks and/or private networks, and in some examples, is a different network than the network connecting the server platform 106 and the client devices 102 (i.e., network 104). The server applications hosted by the server platform 106 may communicate with the microservices deployed at the microservices cloud environment 108 through an application programming interface (API) of the microservices cloud environment 108 that is configured to route various calls and requests received at the microservices cloud environment 108 to a particular microservice, and also provide data returned by the particular microservice to the original requester. In the illustrated embodiment, for example, the API of the microservices cloud environment 108 is implemented at an API server (e.g., “Kube API Server”). The microservices cloud environment 108 may include further components, such as a scheduler, controller manager, shared database, and/or the like, that facilitate the interface between server applications hosted by the server platform 106 and the microservices deployed at the microservices cloud environment, as well as the operation of the microservices themselves. In some embodiments, these components are configured according to the Kubernetes system or framework. For example, a shared database incorporated into the microservices cloud environment is a Kubernetes etcd database.

The microservices cloud environment 108 includes a plurality of virtual computing nodes 110, which may be a virtualization of computing resources available at one or more computing devices or systems belonging to the microservices cloud environment 108. For example, a virtual computing node 110 may be a virtual machine or a physical machine. A virtual computing node 110 is associated with its own set of computing resources, including processing resources (e.g., CPU cores, GPU cores), memory storage resources, and network resources (e.g., bandwidth), and the resources associated with a virtual computing node 110 may be allocated and/or scheduled by the microservices cloud environment 108. Accordingly, different virtual computing nodes may be configured with different resource allocations, and according to aspects of the disclosed technology, certain nodes are more suitable for running some workloads based on a certain node's resource allocation being optimized for the runtime needs of a certain workload.

In the illustrated embodiment, the microservices cloud environment 108 may be a production or user-facing environment, where the microservices are made available for use by the server platform 106. According to aspects of the disclosed technology, the microservices system 100 further includes a testing environment 112 in which microservices can undergo testing and development before being deployed in the microservices cloud environment 108 for end use. For example, the testing environment 112 may be configured to simulate or replicate the microservices cloud environment 108 so that developers and engineers can develop microservice algorithms, dependencies, business logic, and/or the like. In some examples, the testing environment 112 may also be a cloud cluster/environment, like the microservices cloud environment 108, but in other examples, the testing environment 112 may be an on-premises environment or a non-cloud system. In some embodiments, the testing environment 112 and the microservices cloud environment 108 represent portions of a continuous integration and continuous development (CI/CD) pipeline in which microservices are tested first in the testing environment 112 and then sent for deployment (e.g., automatically) in the microservices cloud environment 108. Thus, in some examples, the microservices cloud environment 108 may receive a request to deploy a microservice workload from the testing environment 112 subsequent to the microservice workload being deployed in the testing environment 112. In some other examples, the microservices cloud environment 108 may receive a request to deploy a microservice workload from a user of the server platform 106, for example, to deploy a fully-developed microservice, a third-party microservice, and/or the like.

FIG. 1B illustrates an example of a microservices cloud environment 108, according to example embodiments of the disclosed technology. In example embodiments, the virtual computing nodes 110 are grouped together in node groupings 114 according to the resource optimization of each node. In the illustrated embodiment, virtual computing nodes 110 that are optimized for compute-intensive workloads are identified, and a “compute-intensive” node grouping (i.e., node grouping 114B) is defined to include those identified nodes. Also in the illustrated embodiment, virtual computing nodes 110 that are optimized for memory-intensive workloads (e.g., low-latency connection to physical memory storage devices, increased amount of allocated memory storage) are associated together as a “memory-intensive” node grouping (i.e., node grouping 114D); an “I/O-intensive” node grouping is also defined to include virtual computing nodes 110 optimized for I/O communication (i.e., node grouping 114C).

In example embodiments, a node grouping of non-optimized nodes is also defined (e.g., node grouping 114A in the illustrated embodiment). This non-optimized node grouping may include nodes that are optimized for more than one workload type (e.g., compute-intensive, memory-intensive, I/O-intensive) and nodes having balancing resource capabilities, where no one resource type is predominate over the other resource types.

The definition of node groupings 114 simplifies and abstracts the deployment of microservices within the microservices cloud environment 108. According to aspects of the disclosed technology, the API of the microservices cloud environment 108 is no longer configured to address individual nodes and instead addresses the node groupings 114. Additionally, a microservice can move between different individual nodes within a node grouping 114 while receiving the benefits of resource optimization, because every individual node within the node grouping 114 is resource-optimized for the microservice's performance needs. Further, as discussed in more detail herein, the microservices cloud environment 108 retains a particular node grouping for non-optimized nodes, where microservices whose runtime needs have yet to be ascertained can first be deployed. For example, the particular node grouping including non-optimized nodes may be a staging area where microservices can be deployed first before being re-assigned to a more optimal node grouping.

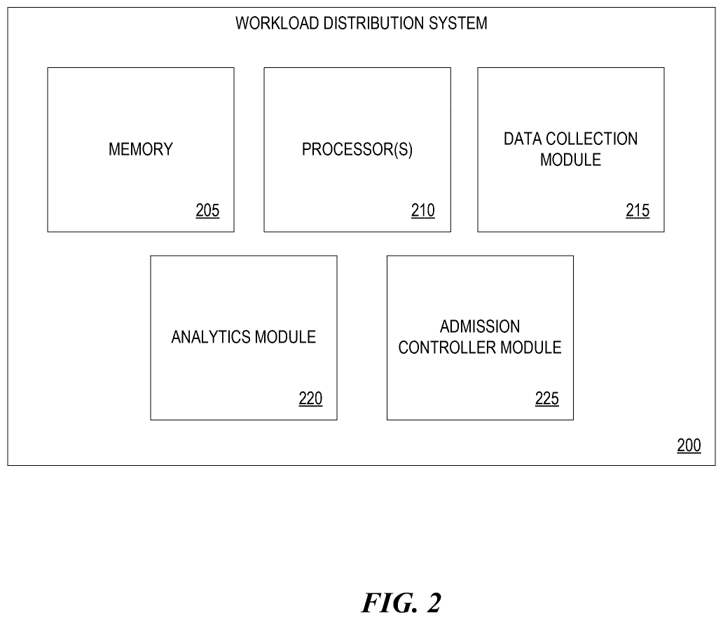

FIG. 2 illustrates an example workload distribution system 200 for implementing solutions for preemptively re-assigning microservices workloads. The workload distribution system 200 (e.g., one or more data processors) is capable of executing algorithms, software routines, and/or instructions to collect performance data for a microservice workload deployed in a cloud environment, generate a two-dimensional prediction regarding a workload type and call volume for the microservice workload, and preemptively re-assign the microservice workload based on the two-dimensional prediction. In some embodiments, the workload distribution system 200 is integrated and/or implemented at a cloud environment where microservice workloads are deployed. For instance, the workload distribution system 200 embodies one or more components of the control plane of the microservices cloud environment 108. In some embodiments, the workload distribution system 200 that implements the solutions disclosed herein is an additional component implemented into a Kubernetes system, such that the workload distribution system 200 can intercept and overwrite deployment requests received by a controller manager of the Kubernetes system.

The workload distribution system 200 can be a general-purpose computer or a dedicated, special-purpose computer. According to the embodiments shown in FIG. 2, the disclosed system can include memory 205, one or more processors 210, data collection module 215, analytics module 220, and admission controller module 225. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 205 can store instructions for running one or more applications or modules on processor(s) 210. For example, memory 205 could be used in one or more embodiments to house all or some of the instructions needed to execute the functionality of the data collection module 215, analytics module 220, and admission controller module 225. Generally, memory 205 can include any device, mechanism, or populated data structure used for storing information. In accordance with some embodiments of the present disclosures, memory 205 can encompass, but is not limited to, any type of volatile memory, nonvolatile memory, and dynamic memory. For example, memory 205 can be random access memory, memory storage devices, optical memory devices, magnetic media, floppy disks, magnetic tapes, hard drives, SIMMs, SDRAM, RDRAM, DDR, RAM, SODIMMs, EPROMS, EEPROMs, compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205.

The data collection module 215 may be configured to collect performance data for a microservice or workload deployed in a microservices cloud environment, such as a production or user-facing environment. The performance data collected by the data collection module 215 thus captures an accurate representation of the workload's runtime performance, including its calls and dependencies on other microservices, and does not simply replicate or simulate the workload's runtime performance. The data collection module 215 may be configured to continuously and/or repeatedly collect performance data for a workload. The performance data captured by the data collection module 215 includes computing resources consumed by the workload in the microservices cloud environment, such as CPU usage, memory usage, and network usage, and call volume for the workload (i.e., a number of requests, queries, or calls for the workload at the given time). The data collection module 215 may include or may be coupled to a database in which the performance data is recorded. From this database, other modules of the workload distribution system 200 may use the performance data collected by the data collection module 215 to perform respective functionalities related to preemptively re-assigning workloads between node groupings of the cloud environment.

The analytics module 220 may be configured to use the performance data captured by the data collection module 215 to generate predictions related to a microservice's workload type and call volume for one or more upcoming time units or time windows. In this regard, the predictions output by the analytics module 220 may be two-dimensional, as the prediction includes both a predicted workload type (e.g., compute-intensive, memory-intensive, I/O-intensive) and a predicted call volume that are linked or correlated to one given upcoming time unit. In some embodiments, the predicted call volume is a binary classification; for example, the analytics module 220 predicts whether the microservice will receive peak call volume or non-peak call volume for an upcoming time unit. According to aspects of the disclosed technology, the analytics module 220 implements machine-learning models to generate the predictions. In particular, in some embodiments, the analytics module 220 includes a first machine learning model configured and trained to determine the predicted workload type for a microservice for an upcoming time unit, and a second machine learning model configured and trained to determine a predicted call volume for the microservice for the upcoming time unit. In some embodiments, the first machine learning model and the second machine learning model generate their respective outputs independently, and the analytics module 220 then correlates or links the respective outputs together for an upcoming time unit.

The admission controller module 225 may be configured to control deployment of a microservice or workload within the microservices cloud environment. The admission controller module 225 may be responsible for identifying a node grouping defined within the microservices cloud environment for a workload and placing the workload in that node grouping. In some embodiments, the admission controller module 225 handles both the initial deployment of new workloads and the re-assignment of already-deployed workloads. For initial deployment, the admission controller module 225 may place the new workload in the non-optimized node grouping, and in doing so, the admission controller module 225 may overwrite any deployment plans, deployment labels, and/or the like included in the deployment request. Accordingly, the admission controller module 225 overrides deployment plans that are not based upon actual workload performance in the present cloud environment. Instead, the admission controller module 225 places the new workload by default in the non-optimized node grouping so that the new workload's runtime performance with respect to the present cloud environment can be most accurately observed.

For re-assignment, the admission controller module 225 relies upon the performance data collected by the data collection module 215 and the predictions generated by the analytics module 220, to determine an optimal node grouping to which a workload should be moved. For example, the admission controller module 225 may determine, based on the predictions from the analytics module 220, that a workload should be placed in the compute-intensive node grouping for a particular upcoming time unit. The admission controller module 225 may then move the workload from its previous node grouping (e.g., the non-optimized node grouping) to the compute-intensive node grouping. According to aspects of the disclosed technology, the admission controller module 225 performs the re-assignment of a workload preemptively at an earlier time unit. In some embodiments, the admission controller module 225 determines that a workload should be re-assigned for an upcoming time unit that is classified as a peak call time for the workload, and the admission controller module 225 executes the re-assignment or move at a prior or preceding time unit that is classified as a non-peak call time for the workload. In this way, workload performance needs can be anticipated and accounted for earlier. This can further enable better allocation and scaling of computing resources among node groupings before the peak hours occur.

### Example Operations for Workload Deployment and Re-Assignment

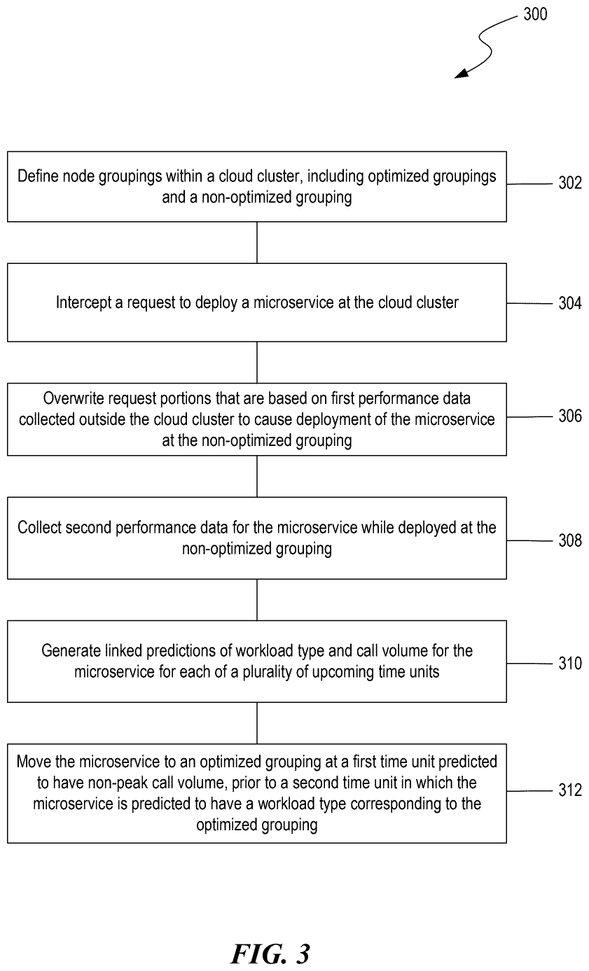

FIG. 3 is a flow diagram illustrating a process 300 used in some implementations for predictive and preemptive (re) deployment of a workload in a cloud cluster/environment. In various implementations, some or all of process 300 is performed by an orchestration system within the cloud/cluster environment, such as, for example, the workload distribution system 200 or a scheduler/controller within the microservices cloud environment 108.

At block 302, the orchestration system defines a plurality of node groupings within a cloud cluster of virtual computing nodes. The plurality of node groupings defined by the orchestration system includes one or more optimized groupings and a non-optimized grouping. In particular, the one or more optimized groupings defined by the orchestration system correspond to one or more workload types that generally describe the needs or characteristics of a given workload's runtime performance. For example, the workload types include compute-intensive, memory-intensive, and network-intensive. Accordingly, an optimized grouping that corresponds to the compute-intensive workload type may include certain nodes of the cluster that are configured with relatively higher compute power. The non-optimized grouping includes certain nodes of the cluster that are not optimized for any one computing resource. For example, the non-optimized grouping includes nodes that have a mixed resource optimization that prioritizes more than one resource (e.g., strong processing power and strong memory capabilities), as well as nodes that have a balanced resource configuration that does not prioritize any resource over another. In a Kubernetes-based system, the grouping to which a given Kubernetes node belongs may be indicated via the taint metadata associated with the given Kubernetes node. In some embodiments, the grouping to which a given Kubernetes node belongs is additionally or alternatively indicated via a NodeType metadata field associated with the given Kubernetes node.

At block 304, the orchestration system intercepts a request to deploy a microservice at the cloud cluster. In some examples, the request originates from a testing environment in which the microservice was previously developed, with the request being automatically or autonomously sent to the cloud cluster (representing a production environment) as part of a continuous delivery pipeline. Accordingly, the request may be intercepted or received subsequent to the microservice being deployed in the testing environment. In other examples, the request is manually transmitted by a user to deploy the microservice.

The request may include a proposed deployment configuration that is based on performance data collected in the testing environment. For example, the request includes one or more labels that indicate a suggested node to deploy the microservice at, a suggested node type to deploy the microservice at, and/or the like. In an example, the labels of the request are indicated in labels and fields in a YAML file included in the request (e.g., a NodeSelector label and a tolerations field, according to a Kubernetes orchestration protocol).

At block 306, the orchestration system may overwrite portions of the request in order to temporarily deploy the microservice at the non-optimized grouping in the cluster. For example, the request may suggest that the microservice be deployed at a certain individual node, or a given individual node that satisfies various conditions or tolerations that may be based on the performance data collected in the testing environment. In order to inform deployment in a cluster/environment-specific manner, the orchestration system accordingly ignores and/or overwrites such suggestions or proposed deployment configurations included in the request. Instead, the orchestration system causes, for every microservice new to the cluster, the microservice to be deployed in the non-optimized grouping. It is within the non-optimized grouping where the microservice workload can immediately begin and performance data collected therefor. In some examples, the non-optimized grouping may therefore be considered a staging area for new microservices before they are optimally assigned to a node grouping.

At block 308, the orchestration system collects second performance data for the microservice, while the microservice is deployed at the non-optimized grouping. In some embodiments, the orchestration system is configured to collect the second performance data using a data collection process that continuously runs for all microservices deployed in the cluster/environment, including this new microservice that is temporarily deployed in the non-optimized grouping.

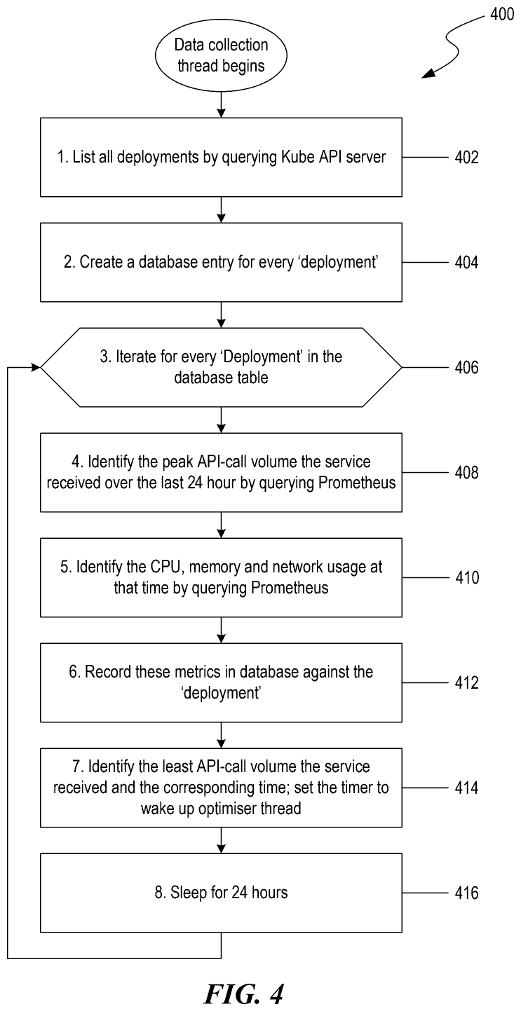

Turning to FIG. 4, the orchestration system or a data collection subsystem implemented therein may perform a process 400 for collecting performance data for microservices deployed in the cluster/environment, according to some embodiments of the disclosed technology. For instance, the process 400 may be implemented by the data collection module 215 of the workload distribution system 200. In some embodiments, the process 400 is implemented as a thread that can execute in parallel with other functionalities and processes described herein.

At block 402, the data collection subsystem identifies all deployments currently in the cluster/environment. At block 404, the data collection subsystem creates a database entry for every deployment. Then, via block 406, the data collection subsystem collects data and populates the database entry for each deployment, by iterating through each deployment in the database. In doing so, the data collection subsystem, at block 408, identifies the peak API call volume for a deployment for the last time unit (e.g., 12 hours, 24 hours, two days, one week). For example, the data collection subsystem determines the maximum number or the cumulative number of calls or queries to the deployment over the last time unit. At block 410, the data collection subsystem also identifies the resource usage of the deployment, including the processing, memory, and network usages. In some embodiments, the data collection subsystem obtains these metrics from a monitoring service included in the cluster/environment, such as the Kubernetes Prometheus monitoring service.

At block 412, the data collection subsystem records these metrics in the database under the entry specific to the deployment.

At block 414, the data collection subsystem also identifies the least API call volume for the deployment in the last time unit and the corresponding time. As some examples, the data collection subsystem may determine that the deployment received its lowest call volume in the first hour of the last twelve-hour window, or that the deployment received the lowest call volume at 3:00 am in the last 24-hour window. In some embodiments, the data collection subsystem sets a timer to wake up another thread that handles re-assignment and movement of workload deployments based on this corresponding time. As a result, re-assignment and movement of a workload deployment may be effectuated at an upcoming time when the workload likely has the least call volume. In some embodiments, according to block 416, the data collection subsystem may sleep for the next time unit (e.g., 12 hours, 24 hours, two days, one week), before repeating the collection of metrics in the following time unit.

As illustrated, the data collection subsystem repeats and iterates the collection of metrics over time. In some embodiments, the data collection subsystem may continue collection of performance in light of version updates for deployments being received and implements on the present cloud cluster/environment. For example, a given deployment identified by the data collection subsystem may receive a version update from the testing environment, and the data collection subsystem continues the collection of performance data, agnostic to the version update. In some embodiments, the data collection subsystem generates a new database entry for the updated deployment and continues collection of the performance data by recording the performance data under the new database entry.

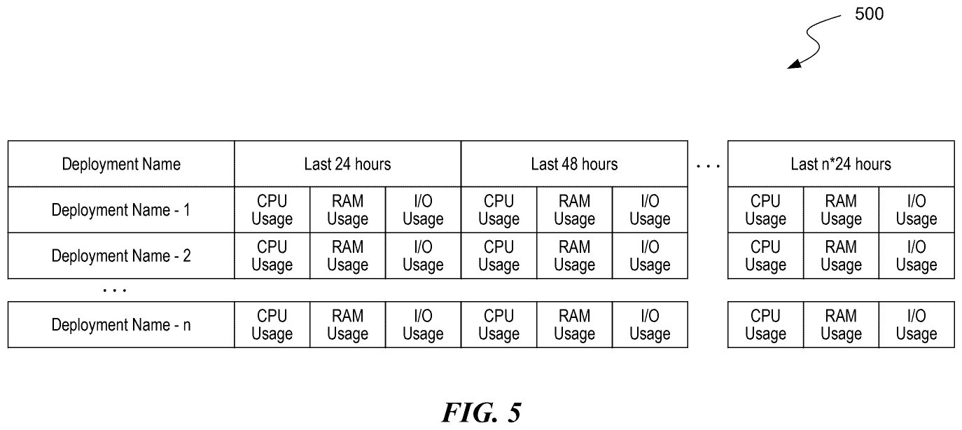

Turning to FIG. 5, an example of performance data 500 collected for multiple deployed workloads is illustrated. The performance data 500 may be collected by a data collection subsystem (e.g., according to process 400) and may be stored in a database in the cloud cluster/environment where the workloads are deployed. As illustrated, the performance data 500 is collected for each of multiple time units, such as 24 hours. In some embodiments, the metrics included in the performance data 500 include usage or consumption of each of a set of computing resources, including processing, memory, and network usages. In some embodiments, the metrics included in the performance data 500 are standardized according to call volume; for example, each metric may be a per-call measurement or value (e.g., CPU usage per call, memory usage per call, network usage per call).

Returning to FIG. 3, at block 310, the orchestration system may generate linked predictions based on the second performance data collected for the microservice (e.g., performance data 500). The linked predictions include predicted workload types and call volumes for a set of upcoming time units. For example, a set of upcoming time units are classified as peak call volume time units or non-peak call volume time units, and each upcoming time unit is associated with a predicted workload type for the microservice based on the collected performance data.

In some embodiments, the orchestration system implements machine learning techniques for generating the linked predictions, or in particular, for generating the predicted workload types and the predicted call volumes. According to aspects of the present disclosure, the orchestration system takes the collected data and uses machine learning to categorize resource use. In some embodiments, the machine learning implementation used by the orchestration system can be continuously adjusted using transfer learning while microservices are updated and added to the cloud cluster/environment. In some embodiments, the orchestration system also uses anomaly detection and Bayesian networks to predict future load needs, labeling each deployment with both time and load information. Beyond just labeling, the orchestration system also adds timers based on these time labels for the services. These timers are used to trigger the next step in the process, specifically the movement or re-assignment of workloads.

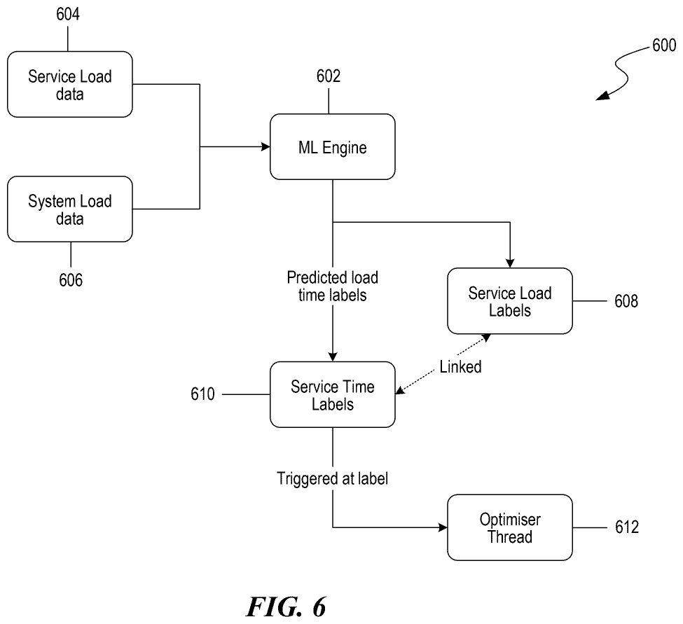

FIG. 6 is a block diagram that illustrates an example machine learning implementation 600 for generating the linked predictions for a workload. According to the illustrated embodiments, a machine learning (ML) engine 602 is configured to receive at least two inputs: service load data 604 and system load data 606. Both the service load data 604 and the system load data 606 are collected while the workload is deployed in a production or user-facing environment. The service load data 604 describes the call volume that the workload has received, and the system load data 606 describes the workload's usage of system resources. The ML engine 602 is configured and trained to determine, from the inputs, at least two outputs: service load labels 608 and service time labels 610. In some embodiments, the ML engine 602 may be configured to accept additional inputs. For example, the ML engine 602 may receive an additional input that represents the proposed deployment configuration included in the request to deploy the workload. In doing so, the ML engine 602 considers and incorporates performance data collected outside of the present cloud cluster/environment, but may do so with reduced and trained weight.

The service load labels 608 represent predicted workload types or categories, and the service load labels 608 may correspond to certain times. For example, the ML engine 602 may determine, for the workload, a service load label 608 that indicates that the workload is compute-intensive, and the service load label 608 may be specific to a certain time of day. On the other hand, the service time labels 610 represent predicted call volume at certain times. For example, the service time labels 610 determined by the ML engine 602 may include peak volume and non-peak volume. In some embodiments, the service time labels 610 may include other levels of call volume, such as an intermediate call volume.

In some embodiments, the service load labels 608 and the service time labels 610 are independently determined by the ML engine 602. For example, the ML engine 602 includes a first machine learning model for determining the service load labels 608 and a second machine learning model for determining the service time labels 610. Depending on the embodiment, the first machine learning model determines the service load labels 608 using the system load data 606, or using both of the service load data 604 and the system load data 606. Depending on the embodiment, the second machine learning model determines the service time labels 610 using the service load data 604, or using both of the service load data 604 and the system load data 606.

In the machine learning implementation 600, the service load labels 608 and the service time labels 610 are linked after being output by the ML engine 602. As each of the service load labels 608 and the service time labels 610 may correspond to certain time units, the service load labels 608 and the service time labels 610 can be linked to the same time units, in some examples. The times for which the service load labels 608 and the service time labels 610 are linked may be a series of time units or time windows, such as the upcoming n number of days (or 24 hour periods). In some embodiments, performance data for deployments are collected for each of these time units, and the ML engine 602 may be re-trained between each time unit to improve model performance over time.

In some embodiments, the service time labels 610 are further used to implement timers that trigger re-deployment or re-assignment of the workload by the optimizer thread 612, or a subsystem or process that performs the workload re-deployment. For instance, the service time labels 610 include at least one upcoming time unit classified as a non-peak time, and a timer is initialized so as to trigger re-deployment at the non-peak time. Because the service time labels 610 may be specific to the workload, re-deployment of workloads deployed within a cloud cluster/environment may be performed on a workload-specific basis at workload-specific times.

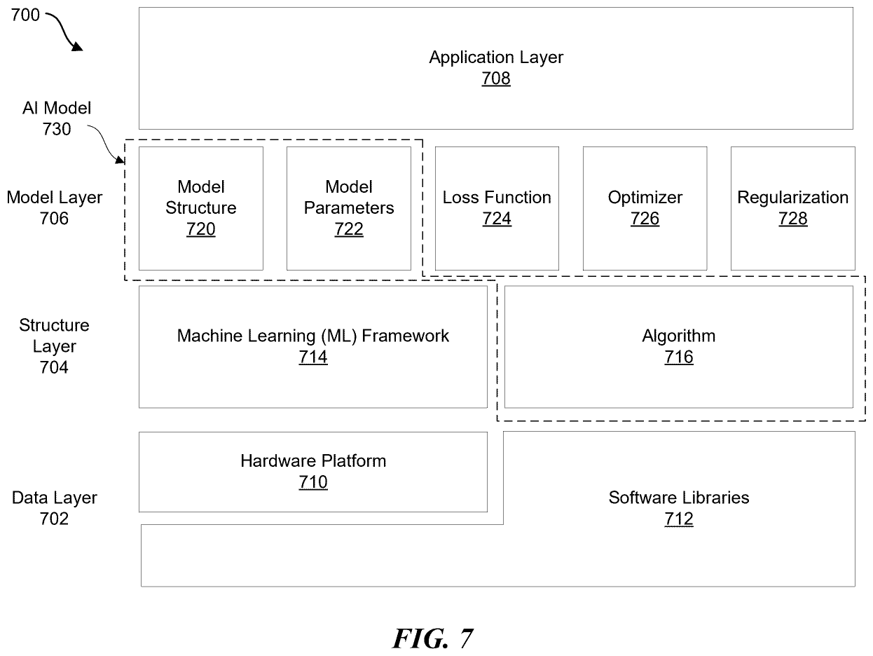

FIG. 7 illustrates an example of an artificial intelligence (AI) system that may implement the ML engine 602, according to example embodiments of the present disclosure. As shown, the AI system 700 can include a set of layers, which conceptually organize elements within an example network topology for the AI system's architecture to implement a particular AI model 730 (e.g., one or both of the machine learning models for outputting service load labels and service time labels). Generally, an AI model 730 is a computer-executable program implemented by the AI system 700 that analyses data to make predictions. Information can pass through each layer of the AI system 700 to generate outputs for the AI model 730. The layers can include a data layer 702, a structure layer 704, a model layer 706, and an application layer 708. The algorithm 716 of the structure layer 704 and the model structure 720 and model parameters 722 of the model layer 706 together form the example AI model 730. The optimizer 726, loss function engine 724, and regularization engine 728 work to refine and optimize the AI model 730, and the data layer 702 provides resources and support for application of the AI model 730 by the application layer 708.

The data layer 702 acts as the foundation of the AI system 700 by preparing data for the AI model 730. As shown, the data layer 702 can include two sub-layers: a hardware platform 710 and one or more software libraries 712. The hardware platform 710 can be designed to perform operations for the AI model 730 and can process amounts of data using one or more servers that perform backend operations such as matrix calculations, parallel calculations, machine learning (ML) training, and the like. Examples of servers used by the hardware platform 710 include central processing units (CPUs) and graphics processing units (GPUs). The hardware platform 710 can also include computer memory for storing data about the AI model 730, application of the AI model 730, and training data for the AI model 730. The computer memory can be a form of random-access memory (RAM), such as dynamic RAM, static RAM, and non-volatile RAM.

The software libraries 712 can be thought of as suites of data and programming code, including executables, used to control the computing resources of the hardware platform 710. The programming code can include low-level primitives (e.g., fundamental language elements) that form the foundation of one or more low-level programming languages, such that servers of the hardware platform 710 can use the low-level primitives to carry out specific operations. The low-level programming languages do not require much, if any, abstraction from a computing resource's instruction set architecture, allowing them to run quickly with a small memory footprint. Examples of software libraries 712 that can be included in the AI system 700 include Intel Math Kernel Library, Nvidia cuDNN, Eigen, and Open BLAS.

The structure layer 704 can include an ML framework 714 and an algorithm 716. The ML framework 714 can be thought of as an interface, library, or tool that allows users to build and deploy the AI model 730. The ML framework 714 can include an open-source library, an application programming interface (API), a gradient-boosting library, an ensemble method, and/or a deep learning toolkit that work with the layers of the AI system facilitate development of the AI model 730. For example, the ML framework 714 can distribute processes for application or training of the AI model 730 across multiple resources in the hardware platform 710. The ML framework 714 can also include a set of pre-built components that have the functionality to implement and train the AI model 730 and allow users to use pre-built functions and classes to construct and train the AI model 730. Thus, the ML framework 714 can be used to facilitate data engineering, development, hyperparameter tuning, testing, and training for the AI model 730. Examples of ML frameworks 714 that can be used in the AI system 700 include TensorFlow, PyTorch, Scikit-Learn, Keras, Cafffe, LightGBM, Random Forest, and Amazon Web Services.

The algorithm 716 can be an organized set of computer-executable operations used to generate output data from a set of input data and can be described using pseudocode. The algorithm 716 can include complex code that allows the computing resources to learn from new input data and create new/modified outputs based on what was learned. In some implementations, the algorithm 716 can build the AI model 730 through being trained while running computing resources of the hardware platform 710. This training allows the algorithm 716 to make predictions or decisions without being explicitly programmed to do so. Once trained, the algorithm 716 can run at the computing resources as part of the AI model 730 to make predictions or decisions, improve computing resource performance, or perform tasks.

The algorithm 716 can be trained using supervised learning, unsupervised learning, semi-supervised learning, and/or reinforcement learning. In some embodiments, the algorithm 716 is repeatedly retrained, for example, using transfer learning. In some embodiments, re-training of the algorithm can incorporate the continuously collected performance data, or generally, updated sets of input data.

Using supervised learning, the algorithm 716 can be trained to learn patterns (e.g., map input data to output data) based on labeled training data. The training data may be labeled by an external user or operator. In an example implementation, training data can include manually-generated load labels for a set of workloads, and in a re-training example, training data can include re-deployment decisions determined for workloads previously. The user may label the training data based on one or more classes and trains the AI model 730 by inputting the training data to the algorithm 716. The algorithm determines how to label the new data based on the labeled training data. The user can facilitate collection, labeling, and/or input via the ML framework 714. In some instances, the user may convert the training data to a set of feature vectors for input to the algorithm 716. Once trained, the user can test the algorithm 716 on new data to determine if the algorithm 716 is predicting accurate labels for the new data. For example, the user can use cross-validation methods to test the accuracy of the algorithm 716 and retrain the algorithm 716 on new training data if the results of the cross-validation are below an accuracy threshold.

Supervised learning can involve classification and/or regression. Classification techniques involve teaching the algorithm 716 to identify a category of new observations based on training data and are used when input data for the algorithm 716 is discrete. For example, when learning through classification techniques, the algorithm 716 receives training data labeled with categories (e.g., classes) and determines how features observed in the training data (e.g., patterns in resource usage over time) relate to the categories (e.g., workload types including compute-intensive, memory-intensive, and network-intensive). Once trained, the algorithm 716 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 716 is continuous. Regression techniques can be used to train the algorithm 716 to predict or forecast relationships between variables. To train the algorithm 716 using regression techniques, a user can select a regression method for estimating the parameters of the model. The user collects and labels training data that is input to the algorithm 716 such that the algorithm 716 is trained to understand the relationship between data features and the dependent variable(s). Once trained, the algorithm 716 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 716 learns patterns from unlabeled training data. In particular, the algorithm 716 is trained to learn hidden patterns and insights of input data, which can be used for data exploration or for generating new data. Here, the algorithm 716 does not have a predefined output, unlike the labels output when the algorithm 716 is trained using supervised learning. For example, unsupervised learning is used to train the algorithm 716 to find an underlying structure of a set of data, group the data according to similarities, and represent that set of data in a compressed format. For example, the ML engine 602 can use unsupervised learning to identify patterns in resource usage to determine peak times and non-peak times for a workload and to determine workload types over time for the workload.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 716 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 716 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 716 include factor analysis, item response theory, latent profile analysis, and latent class analysis.

The model layer 706 implements the AI model 730 using data from the data layer and the algorithm 716 and ML framework 714 from the structure layer 704, thus enabling decision-making capabilities of the AI system 700. In some embodiments, the model layer 706 includes a model structure 720, model parameters 722, a loss function engine 724, an optimizer 726, and a regularization engine 728.

The model structure 720 describes the architecture of the AI model 730 of the AI system 700. The model structure 720 defines the complexity of the pattern/relationship that the AI model 730 expresses. Examples of structures that can be used as the model structure 720 include decision trees, support vector machines, regression analyses, Bayesian networks, Gaussian processes, genetic algorithms, and artificial neural networks (or, simply, neural networks). The model structure 720 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 720 may include one or more hidden layers of nodes between the input and output layers. The model structure 720 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 722 represent the relationships learned during training and can be used to make predictions and decisions based on input data. The model parameters 722 can weight and bias the nodes and connections of the model structure 720. For instance, when the model structure 720 is a neural network, the model parameters 722 can weight and bias the nodes in each layer of the neural networks, such that the weights determine the strength of the nodes and the biases determine the thresholds for the activation functions of each node. The model parameters 722, in conjunction with the activation functions of the nodes, determine how input data is transformed into desired outputs. The model parameters 722 can be determined and/or altered during training of the algorithm 716.

The loss function engine 724 can determine a loss function, which is a metric used to evaluate the AI model's 730 performance during training. For instance, the loss function engine 724 can measure the difference between a predicted output of the AI model 730 and the actual output of the AI model 730 and is used to guide optimization of the AI model 730 during training to minimize the loss function. In some instances, the algorithm 716 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 726 adjusts the model parameters 722 to minimize the loss function during training of the algorithm 716. In other words, the optimizer 726 uses the loss function generated by the loss function engine 724 as a guide to determine what model parameters lead to the most accurate AI model 730. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 726 used may be determined based on the type of model structure 720 and the size of data and the computing resources available in the data layer 702.

The regularization engine 728 executes regularization operations. Regularization is a technique that prevents over- and under-fitting of the AI model 730. Overfitting occurs when the algorithm 716 is overly complex and too adapted to the training data, which can result in poor performance of the AI model 730. Underfitting occurs when the algorithm 716 is unable to recognize even basic patterns from the training data such that it cannot perform well on training data or on validation data. The regularization engine 728 can apply one or more regularization techniques to fit the algorithm 716 to the training data properly, which helps constraint the resulting AI model 730 and improves its ability for generalized application. Examples of regularization techniques include lasso (L1) regularization, ridge (L2) regularization, and elastic (L1 and L2 regularization).

The application layer 708 describes how the AI system 700 is used to solve problem or perform tasks. In an example implementation, the application layer 708 can include the ML engine 602 for generating service time labels and service load labels for a workload. In some embodiments, the AI system 700 itself may be implemented as a microservice within the cloud cluster/environment, and the application layer 708 enables the orchestration system to query the AI system 700, for example with cluster-specific performance data for a workload, and receive outputs from the AI system 700, including workload type and call volume predictions for the workload.

Returning to FIG. 3, at block 312, the orchestration system moves, transfers, or re-assigns the microservice to an optimized grouping based on the linked predictions. In particular, the orchestration system moves the microservice to an optimized grouping that corresponds to a predicted workload type of the microservice (e.g., compute-intensive, memory-intensive, network-intensive). In some embodiments, the orchestration system moves the microservice according to a predicted workload type that is linked to a peak call volume time. In some embodiments, the orchestration system performs the move at a non-peak call volume time that occurs prior to the peak call volume time, and the move may be triggered based on a timer that indicates the non-peak time. As a result, the workload is already in the optimal node group before its peak time begins. The cloud cluster/environment may implement a container system in which workloads are packaged and instantiated in containers, and the orchestration system causes the containers to move to a node group accordingly.

The microservice may be placed in the optimized grouping at least for the duration of the predicted peak call volume time. In some embodiments, the orchestration system automatically returns the microservice to the non-optimized grouping at the conclusion of the predicted peak call volume time. In some embodiments, at least a portion of the process 300 is performed while the microservice is placed in the optimized grouping, such that the microservice may move from the optimized grouping to another optimized grouping in some instances.

In some embodiments, the predicted workload type of the microservice is a non-dominant type, or none of compute-intensive, memory-intensive, or network-intensive. In such examples, the orchestration system may determine to let the microservice remain in the non-optimized node grouping for at least a number of upcoming time units.

In some embodiments, the orchestration system causes the movement of a workload based on writing or overwriting deployment metadata associated with the workload. For example, in a Kubernetes system, the workload is associated with tolerations deployment metadata that causes the workload to be placed at nodes with corresponding taint values. In order to cause a workload to be moved, the orchestration system may modify tolerations fields in the deployment metadata for the workload, which then causes a native controller manager in the Kubernetes system to move or schedule the workload to another node or node grouping.

Accordingly, the process 300 enables microservices to be deployed and then re-deployed to resource-optimal node groupings on a preemptive basis with respect to peak call volume times. Whenever a user or CD pipeline attempts to make a deployment, a cloud cluster/environment's admission controller inserts or overwrites deployment labels associated with the workload to cause the workload to be deployed at a non-optimized group. A data collection thread monitors and builds a database for every deployment, for example, by querying a monitoring service of the cloud cluster/environment. During off-peak hours, an optimizer thread for moving workload deployments may be scheduled to run. The optimizer thread makes a judgment on every deployment if it is compute-intensive, memory-intensive, network-intensive, or none of the foregoing. In some embodiments, deployment metadata associated with the workload is modified accordingly. Then, in some embodiments, a default or native deployment controller watches the changes to the deployment metadata, and it starts running whenever the deployment metadata is changed. The deployment controller moves the containers belonging to the workload or microservice accordingly. The monitoring and re-deployments of a workload can continue over time, even when the workload itself and/or the microservices it might interact with are updated and changed.

### Example Computing Environments or Devices

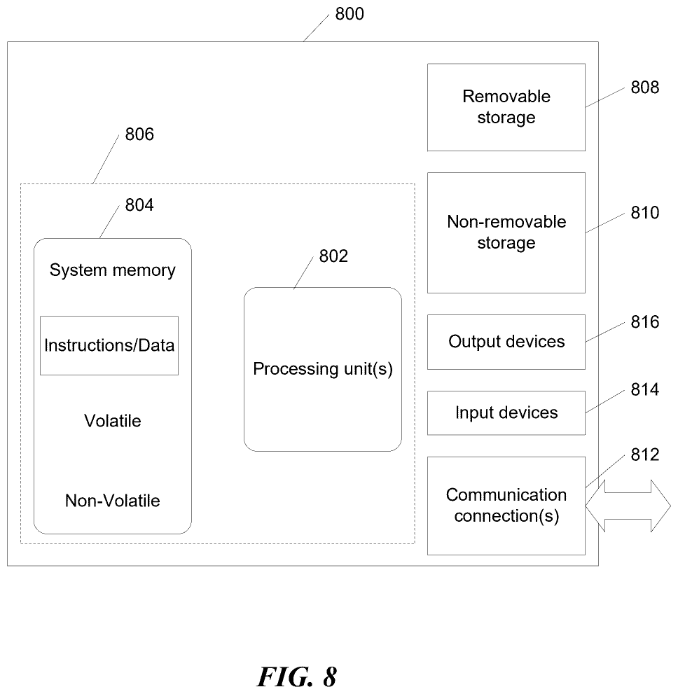

FIG. 8 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 800 typically includes at least one processing unit 802 and memory 804. Depending on the exact configuration and type of computing device, memory 804 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 8 by dashed line 806. Further, environment 800 may also include storage devices (removable 808 and/or non-removable 810) including, but not limited to, magnetic or optical disks or tape. Similarly, environment 800 may also have input device(s) 814 such as keyboard, mouse, pen, voice input, etc., and/or output device(s) 816 such as a display, speakers, printer, etc. Also included in the environment may be one or more communication connections, 812, such as Bluetooth, WiFi, WiMax, LAN, WAN, point to point, etc.

Operating environment 800 typically includes at least some form of computer readable media. Computer readable media can be any available media that can be accessed by processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 800 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

### CONCLUSION

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively.

Several implementations of the disclosed technology are described above in reference to the figures. The computing devices on which the described technology may be implemented can include one or more central processing units, memory, user devices (e.g., keyboards and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

1. A distributed computing system comprising:
a first plurality of virtual computing nodes, at least one of the first plurality of virtual computing nodes being optimized for one of a plurality of workload types;
a second plurality of virtual computing nodes that forms a testing environment that simulates a user-facing environment defined by the first plurality of virtual computing nodes; and
a controller subsystem comprising at least one processor and at least one memory storing instructions that, when executed by the at least one processor, cause the controller subsystem to:
define a plurality of node groupings for the user-facing environment, the plurality of node groupings comprising (i) one or more groupings of the first plurality of virtual computing nodes corresponding to each of the plurality of workload types and (ii) a particular grouping of the first plurality of virtual computing nodes that includes non-optimized nodes of the first plurality of virtual computing nodes that are unoptimized for the plurality of workload types;
subsequent to first performance data being collected for a microservice in the testing environment, intercept a request to deploy the microservice in the user-facing environment, wherein the request includes a proposed deployment configuration based on the first performance data;
overwrite the proposed deployment configuration in the request in order to temporarily deploy the microservice at the particular grouping in the user-facing environment that includes the non-optimized nodes;
collect second performance data for the microservice in the user-facing environment while the microservice is deployed at the particular grouping;
generate, via both of a first machine learning model and a second machine learning model, a linked prediction that includes predicted workload types for a set of predicted peak times and predicted non-peak times based on the second performance data, wherein the first machine learning model is trained to independently output the predicted workload types for a series of subsequent times and the second machine learning model is trained to independently classify the series of subsequent times into the set of predicted peak times and predicted non-peak times; and
transfer, during a predicted non-peak time, the microservice from the particular grouping that includes non-optimized nodes to a grouping corresponding to a predicted workload type linked to a predicted peak time following the predicted non-peak time.

2. The distributed computing system of claim 1, wherein the instructions further cause the controller subsystem to:
subsequent to receiving a version update for the microservice via the testing environment, continue collection of the second performance data in the user-facing environment; and
determine whether to transfer the microservice to a new grouping of the plurality of node groupings according to a second linked prediction generated from the continued collection of the second performance data.

3. The distributed computing system of claim 1, wherein the proposed deployment configuration is overwritten based on the first performance data being collected while the microservice is deployed in isolation in the testing environment without interfacing with other microservices, and wherein the second performance data is collected while the microservice is deployed in the user-facing environment with dependencies on the other microservices.

4. The distributed computing system of claim 1, wherein the second performance data for the microservice includes a per-call measurement that is determined using a call volume for the microservice in the user-facing environment.

5. The distributed computing system of claim 4, wherein the second machine learning model is configured to classify the series of subsequent times into the set of predicted peak times and predicted non-peak times based on the call volume for the microservice in the user-facing environment while the microservice is deployed at the particular grouping.

6. The distributed computing system of claim 1, wherein the instructions further cause the controller subsystem to:
re-train, between each of the series of subsequent times, each of the first machine learning model and the second machine learning model using the second performance data.

7. The distributed computing system of claim 1, wherein moving the microservice during the predicted non-peak time comprises setting a timer between a current time and the predicted non-peak time in order to automatically trigger movement of the microservice at during the predicted non-peak time.

8. The distributed computing system of claim 1, wherein the instructions further cause the controller subsystem to:
return the microservice to the particular grouping of the first plurality of virtual computing nodes that includes non-optimized nodes at an end of the predicted peak time following the predicted non-peak time.

9. A method for workload distribution across a plurality of virtual computing nodes that define a microservices environment, the method comprising:
defining a plurality of node groupings for the microservices environment, the plurality of node groupings comprising (i) one or more groupings comprising virtual computing nodes optimized for a respective one of a plurality of workload types and (ii) a particular grouping that comprises non-optimized nodes of the plurality of virtual computing nodes;
receiving a request to deploy a microservice in the microservices environment, the request including a proposed deployment configuration based on first performance data collected for the microservice in a testing environment that simulates the microservices environment;
overwriting the proposed deployment configuration in the request in order to temporarily deploy the microservice at the particular grouping that comprises the non-optimized nodes;
collecting second performance data for the microservice in the microservices environment while the microservice is deployed at the particular grouping;
generating, via both of a first machine learning model and a second machine learning model, a linked prediction that includes predicted workload types for a set of predicted peak times and predicted non-peak times based on the second performance data, wherein the first machine learning model is trained to independently output the predicted workload types for a series of subsequent times and the second machine learning model is trained to independently classify the series of subsequent times into the set of predicted peak times and predicted non-peak times; and
re-assigning, during a predicted non-peak time, the microservice from the particular grouping that includes non-optimized nodes to a grouping corresponding to a predicted workload type linked to a predicted peak time following the predicted non-peak time.

10. The method of claim 9, further comprising:
subsequent to receiving a version update for the microservice via the testing environment, continuing collection of the second performance data in the microservices environment; and
determining whether to re-assign the microservice to a new grouping according to a second linked prediction generated from the continued collection of the second performance data.

11. The method of claim 9, wherein the proposed deployment configuration is overwritten based on the first performance data being collected while the microservice is deployed in isolation in the testing environment without interfacing with other microservices, and wherein the second performance data is collected while the microservice is deployed in the microservices environment with dependencies on the other microservices.

12. The method of claim 9, wherein the second performance data for the microservice includes a per-call measurement that is determined using a call volume for the microservice in the microservices environment.

13. The method of claim 12, wherein the second machine learning model is configured to classify the series of subsequent times into the set of predicted peak times and predicted non-peak times based on the call volume for the microservice in the microservices environment while the microservice is deployed at the particular grouping.

14. The method of claim 9, further comprising:
re-training, between each of the series of subsequent times, each of the first machine learning model and the second machine learning model using the second performance data.

15. A non-transitory computer-readable medium storing instructions that, when executed by a computing system, cause the computing system to perform operations comprising:
defining a plurality of node groupings for a microservices environment defined by a plurality of virtual computing nodes, the plurality of node groupings comprising a non-optimized node grouping and one or more optimized node groupings each corresponding to one of a plurality of workload types;
receiving a request to deploy a microservice in the microservices environment, the request including a proposed deployment configuration based on a deployment of the microservice in a testing environment associated with the microservices environment;
overwriting the proposed deployment configuration in the request in order to temporarily deploy the microservice at the non-optimized node grouping;
collecting performance data for the microservice while the microservice is temporarily deployed in the microservices environment at the non-optimized node grouping;
generating, via both of a first machine learning model and a second machine learning model, a linked prediction that includes predicted workload types for a set of predicted peak times and predicted non-peak times based on the second performance data, wherein the first machine learning model is trained to independently output the predicted workload types for a series of subsequent times and the second machine learning model is trained to independently classify the series of subsequent times into the set of predicted peak times and predicted non-peak times; and
re-assigning, during a predicted non-peak time, the microservice from the non-optimized node grouping that includes non-optimized nodes to an optimized nod grouping corresponding to a predicted workload type linked to a predicted peak time following the predicted non-peak time.

16. The non-transitory computer-readable medium of claim 15, wherein the operations further comprise:
subsequent to receiving a version update for the microservice via the testing environment, continuing collection of the second performance data in the microservices environment; and
determining whether to re-assign the microservice to a new optimized node grouping according to a second linked prediction generated from the continued collection of the second performance data.

17. The non-transitory computer-readable medium of claim 15, wherein the proposed deployment configuration is overwritten based on the first performance data being collected while the microservice is deployed in isolation in the testing environment without interfacing with other microservices, and wherein the second performance data is collected while the microservice is deployed in the microservices environment with dependencies on the other microservices.

18. The non-transitory computer-readable medium of claim 15, wherein the second performance data for the microservice includes a per-call measurement that is determined using a call volume for the microservice in the microservices environment.

19. The non-transitory computer-readable medium of claim 18, wherein the second machine learning model is configured to classify the series of subsequent times into the set of predicted peak times and predicted non-peak times based on the call volume for the microservice in the microservices environment while the microservice is deployed at the non-optimized node grouping.

20. The non-transitory computer-readable medium of claim 15, wherein the operations further comprise:
re-training, between each of the series of subsequent times, each of the first machine learning model and the second machine learning model using the second performance data.
